(19) United States
(12) Patent Application Publication
(10) Pub. No.: US 2017/0185680 A1
(43) Pub. Date: Jun. 29, 2017

(54) CHINESE WEBSITE CLASSIFICATION METHOD AND SYSTEM BASED ON CHARACTERISTIC ANALYSIS OF WEBSITE HOMEPAGE

(71) Applicants: SURFILTER NETWORK TECHNOLOGY CO., LTD, Shenzhen, Guangdong (CN); SOUTH CHINA UNIVERSITY OF TECHNOLOGY, Guangzhou, Guangdong (CN)

(72) Inventors: Xinmin Tang, Shenzhen, Guangdong (CN); Zhijie Shen, Shenzhen, Guangdong (CN); Xiaojun Jing, Shenzhen, Guangdong (CN); Yi Cai, Guangzhou, Guangdong (CN); Zhiwei Cai, Guangzhou, Guangdong (CN)

(21) Appl. No.: 15/325,083

(22) PCT Filed: Dec. 18, 2014
(86) PCT No.: PCT/CN2014/094220

§ 371 Date: Jan. 9, 2017

(30) Foreign Application Priority Data
Oct. 17, 2014 (CN) 201410555450.7

(51) Int. Cl. G06F 17/30; H04L 29/08

(52) U.S. Cl. CPC G06F 17/30864; H04L 67/02; H04L 67/2804; H04L 67/2823; G06F 17/30598

(57) ABSTRACT

Disclosed are a Chinese website classification method and system based on characteristic analysis of a website homepage. The method specifically comprises the following steps: S1, crawling website content; S2, labeling a website type; S3, extracting website information; S4, calculating a weight and representing the weight in the form of a characteristic vector; and S5, classifying the website by comparing the characteristic vector. By utilizing the above Chinese website classification method and system, the noise interference can be alleviated to the greatest extent by only extracting a title and meta-information of the website; by means of pre-processing and characteristic vector expression, the characteristics of the website are accurately expressed with the vector, so that the accuracy of classification is increased; and since only the title and meta-information of the website need to be processed, the quantity of data to be processed is small, and the processing speed is high.

### TECHNICAL FIELD

The present application relates to the field of internet, and more particularly relates to a Chinese website classification method and a Chinese website classification system based on characteristic analysis of website homepage.

### BACKGROUND

As the maturation and development of the internet and related technologies, the internet information is being produced explosively. On the one hand the need of information from the users is satisfied, and on the other hand it is also difficult for the information classification and the network supervision from the government. Website classification technology is the core technology to solve these problems.

The website classification methods in the prior art mainly classify the web sites according to the text classification of the homepage and the sub page of the websites. The main realization processes is as follows. Firstly, the text contents are extracted from the web page, and then classified to get a classification category which is the classification category of the web page. But these methods are vulnerable to some of the noise in the website. For some websites with poor quality, it is difficult to achieve satisfactory results.

### SUMMARY

The objective of the present application is to provide a Chinese website classification method and system based on characteristic analysis of web site homepage, aiming at the above-mentioned drawback, to reduce noise interference in the classification process, improve the accuracy of classification, and speed up the processing speed.

According to one aspect, a Chinese website classification method based on characteristic analysis of website homepage is provided, which comprises following steps:

step S1, crawling one to more websites and extracting contents of the websites;

step S2, selecting a pre-set quantity of crawled websites for manual classification and labeling the crawled websites;

step S3, parsing homepages of all crawled websites to extract titles and meta-information therein, wherein the meta-information comprises key words and description;

step S4, pre-processing the titles and the meta-information, calculating weights thereof, and representing the titles and the meta-information in forms of characteristic vectors according to the weights;

step S5, comparing all of the characteristic vectors with characteristic vectors of the manually classified and labeled websites to classify the websites.

Preferably, the step S1 further comprises:

step S11, selecting a plurality of websites and placing selected websites into a website queue to be crawled in order;

step S12, successively crawling the contents of selected websites in order;

step S13, extracting all links of the crawled websites, and placing websites not been crawled to the website queue to be crawled;

step S14, determining whether the number of the crawled websites reaches a preset value or the website queue to be crawled is empty; if the number of the crawled websites does not reach the preset value or the website queue to be crawled is not empty, returning to step S12, if the number of the crawled websites reaches the preset value or the website queue to be crawled is empty, going to the step S2.

Preferably, the step S2 further comprises:

step S21, randomly selecting one unlabeled website;

step S22, manually labeling selected website;

step S23, determining whether the number of the labeled websites reaches a preset value; if not, returning to the step S21, or else, going to the step S3.

Preferably, the step S3 further comprises:

step S31, detecting character encoding formats of all the crawled websites, and decoding the contents of all the crawled websites;

step S32, reading HTML contents of the homepages of all the crawled websites, and parsing the HTML contents to be content document object models;

step S33, extracting text contents of the titles, key words of metadata and text contents of description from the content document object models;

step S34, arranging the text contents of the titles, the key words of metadata and the text contents of the description in interval spaces in a whole text.

Preferably, the step S4 further comprises:

step S41, obtaining multiple segment words based on the whole text;

step S42, calculating feature weights of the multiple segment words;

step S43, representing the whole text as the characteristic vectors based on the feature weights.

Preferably, in the step S42 the feature weights are TFIDF values of the segment words, which can be calculated as follows:

TFIDF(w)=TF(w)*IDF(w)

Wherein, the value of the TF(w) is occurrence times of w in the feature weights of all the crawled websites,

$$IDF ( w ) = log ( \frac{total}{occur ( w )} )$$

wherein total denotes the number of the feature weights of all the crawled websites, the value of occur(w) is the number of the feature weights of the crawled websites containing w.

Preferably, the characteristic vector in the step S43 is (t1:w1, . . . , ti:wi, . . . , tn:wn), wherein t1, . . . , ti, . . . , tn denote the segment words obtained from the whole text; n denotes the total number of the characteristic vectors in a sample; wherein wi denotes the weight of ti calculated from the step S42, and i denotes an integer from 1 to n.

Preferably, K-nearest neighbor algorithm is performed in the step S5.

According to another aspect, a Chinese website classification system based on characteristic analysis of website homepage is also provided here, which comprising a website crawling module configured for crawling one to more websites and extracting contents of the websites, a labeling module configured for manually labeling websites, an information extracting module configured for parsing homepages of the websites and extracting titles and meta-information therein, a processing module and a classifying module configured for classifying the websites.

In the present embodiment, the website crawling module is configured for crawling one to more websites, extracting the contents of the websites and sending the same to the labeling module and the information extracting module.

The labeling module is configured for selecting a pre-set quantity of the crawled websites for manual classification and labeling the websites.

The information extracting module is configured for parsing homepages of all crawled websites to extract titles and meta-information therein and sending the titles and the meta-information to the processing module; wherein the meta-information comprises key words and description.

The processing module is configured for pre-processing the titles and the meta-information, calculating weights thereof, representing the titles and the meta-information in forms of characteristic vectors to the weight, and sending the characteristic vectors to the classifying module.

The classifying module is configured for comparing all of the characteristic vectors with the characteristic vectors of the manually classified and labeled websites to classify the websites.

Preferably, the processing module further comprises a pre-processing module and a vector representation module.

In a preferable embodiment, the website crawling module is configured for selecting one or more websites and placing selected websites into a website queue to be crawled in order; successively crawling the contents of selected websites in order; extracting all of links of crawled websites, and placing the websites not been crawled to the website queue to be crawled; determining whether the number of the crawled websites reaches a preset value or the website queue to be crawled is empty, if the number of the crawled web sites does not reach the preset value or the web site queue to be crawled is not empty, extracting the web site links and crawling the websites successively and repeatedly until the number of the crawled websites reaches the preset value or the website queue to be crawled is empty; if the number of the crawled websites reaches the preset value or the website queue to be crawled is empty, stopping crawling. The website crawling module is further configured for sending the crawled websites to the labeling module and the information extracting module.

The labeling module is configured for randomly selecting one unlabeled website after receiving the crawled websites from the website crawling module; manually labeling selected websites. Then the labeling module is further configured for determining whether the number of the labeled website reaches a preset value, if yes, randomly selecting one unlabeled website and manually labeling the selected website successively and repeatedly until the number of the labeled websites reaches the preset value; or else, stopping labeling. The labeling module is configured for sending website categories to the classifying module.

The information extracting module is configured for detecting character encoding formats of all the crawled websites, and decoding the contents of all the crawled websites after receiving the crawled websites from the website crawling module; then reading the HTML contents of the homepages of all the crawled websites, and parsing the HTML contents to be content document object models; then extracting text contents of the titles, key words of metadata and text contents of the description from the content document object models; arranging the text contents of the titles, the key words of metadata and the text contents of the description in interval spaces in a whole text. The information extracting module is further configured for finally sending website categories to the classifying module.

The processing module is configured for obtaining multiple segment words based on the whole text after receiving the whole text; calculating feature weights of the multiple segment words; representing the whole text as the characteristic vectors based on the feature weights; sending the characteristic vectors to the classifying module.

Wherein, the pre-processing module is configured for obtaining multiple segment words based on the whole text received from the information extracting module; calculating feature weights of the multiple segment words. The pre-processing module is further configured for taking TFIDF values of the segment words as the feature weights; and sending the feature weights to the vector representation module. Wherein the TFIDF value can be calculated as follows:

TFIDF(w)=TF(w)*IDF(w).

Wherein the value of the TF(w) is occurrence times of w in the feature weights of all the crawled web sites,

$$IDF ( w ) = log ( \frac{total}{occur ( w )} ) .$$

Wherein total denotes the number of the feature weights of all the crawled websites, the value of occur(w) is the number of the feature weights of the crawled web sites containing w.

The vector representation module is configured for representing the characteristic vectors received from the pre-processing module as follows: (t1:w1, . . . , ti:wi, . . . , tn:wn), wherein t1, . . . , ti, . . . , tn denote the segment words obtained from the whole text; n denotes the total number of the characteristic vectors in a sample; wherein wi denotes the weight of ti calculated from the step S42, and i denotes an integer from 1 to n.

The classifying module is configured for comparing characteristic vectors needed to be classified with the characteristic vectors manually labeled to classify the crawled websites after receiving the website categories from the labeling module and the characteristic vectors from the processing module.

For implementation, the following advantageous effects can be achieved. The noise interference can be alleviated to the greatest extent by extracting only the titles and meta-information of the websites. By means of pre-processing and characteristic vector representation, the characteristics of the websites are accurately represented with the vectors, thus the accuracy of classification is increased. And since only titles and meta-information of the websites need to be processed, the quantity of data to be processed is small, and the processing speed is high.

### BRIEF DESCRIPTION OF THE DRAWINGS

The present application will be further described with reference to the accompanying drawings and embodiments in the following, in the accompanying drawings:

FIG. 1 is a flow chart of a Chinese website classification method based on characteristic analysis of web site homepage, according to the present application.

FIG. 2 is a flow chart for website crawling of FIG. 1.

FIG. 3 is a flow chart for website labeling of FIG. 1.

FIG. 4 is a flow chart for website information extracting of FIG. 1.

FIG. 5 is a flow chart for website processing of FIG. 1.

FIG. 6 is a flow chart for website classifying of FIG. 1.

FIG. 7 is a block diagram of a Chinese website classification system based on characteristic analysis of web site homepage, according to the present application.

### DETAILED DESCRIPTION OF THE PREFERRED EMBODIMENT

Aiming at the problems of the noise interference and greatly varied information quality of the Chinese websites based on homepage feature extraction and weight setting thereof, the present application provides a Chinese web site classification method and system based on characteristic analysis of web site homepage, in which the noise interference can be alleviated to the greatest extent by extracting only the titles and meta-information of the websites, and by means of pre-processing and characteristic vector representation, the characteristics of the web sites are accurately represented with the vector, thus the accuracy of classification is increased. Furthermore, since only titles and meta-information of the websites need to be processed, the quantity of data to be processed is small, and the processing speed is high.

To make the technical feature, objective and effect of the present application be understood more clearly, now the specific implementation of the present application is described in detail with reference to the accompanying drawings and embodiments.

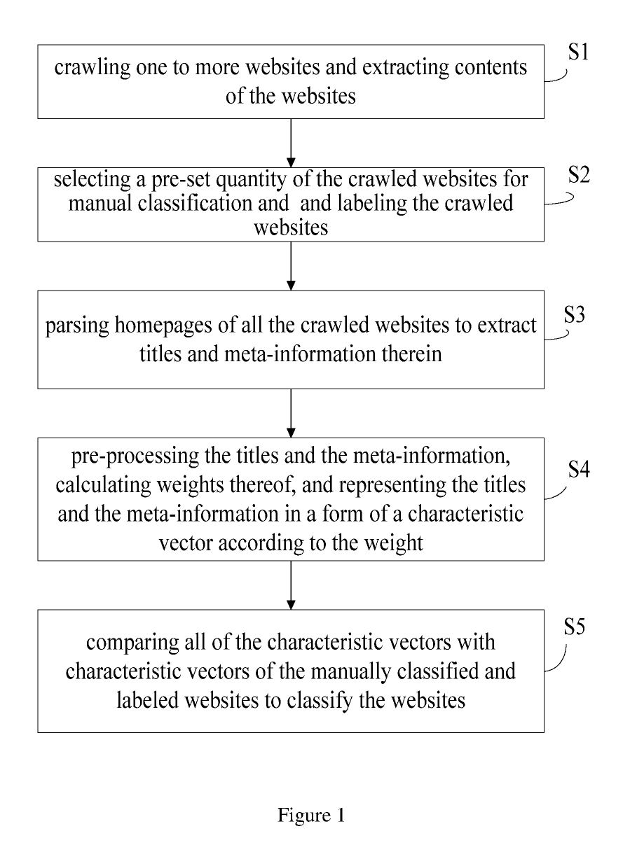

FIG. 1 is a flow chart of a Chinese website classification method based on characteristic analysis of website homepage, according to the present application, which Figure relates to a Chinese website classification method based on characteristic analysis of website homepage, specially comprises following steps.

In step S1, according to the web crawler technology, more websites are found by starting from a few web sites via a width optimization search method based on the links between the websites. The pages of the websites are saved to the local server to crawl one to more websites and extract the contents of the crawled websites. For a large-scale search engine, the distributed crawler server can be used to crawl the required websites, however for a lightweight search engine, a single crawler computer can be used to crawl the required websites.

In step S2, a pre-set quantity of the crawled websites are selected for manual classification and labeled. A random or an active learning mode can be used to select and label the websites with the most information from all of the crawled websites, so as to achieve less labeled websites but with better accuracy rate.

In step S3, the homepages of all the crawled websites are parsed so that the program can automatically identify text contents of the titles and contents of the meta-information and extract titles and meta-information therein. Wherein, the meta-information comprises key words and description.

In step S4, the titles and the meta-information are pre-processed, that is applying the processes such as word segmentation, stopping and removing, and so on, to the text of the titles and the meta-information, and then the weights of the words in the pre-processed text are calculated, and finally based on the calculated weights, the titles and the meta-information are represented in the form of characteristic vectors.

In step S5, all of the characteristic vectors formed by the crawled websites are compared with characteristic vectors formed by the manually classified and labeled websites to determine the category of the crawled websites, thus to classify the crawled websites.

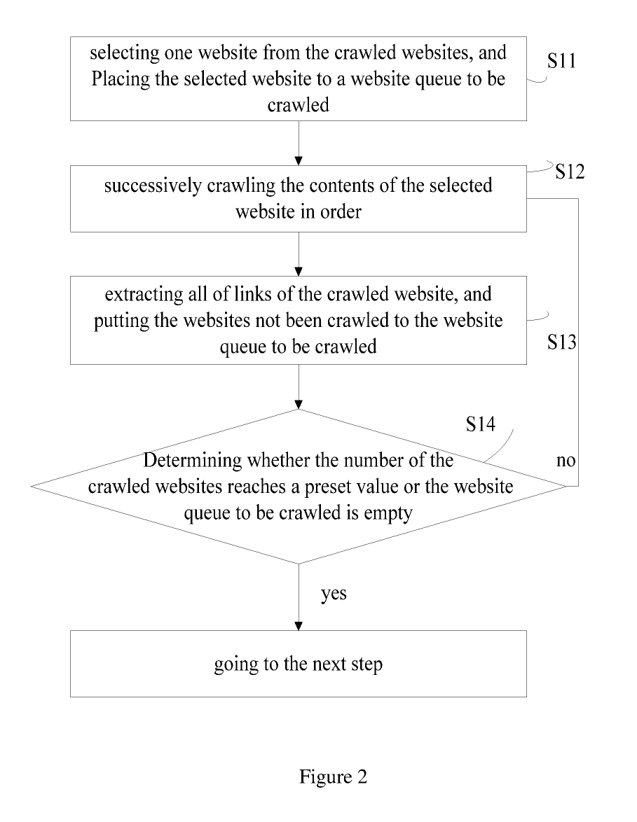

As shown in FIG. 2, in this embodiment, FIG. 2 is a flow chart for website crawling of FIG. 1, in which the step S1 for website crawling specially comprises following steps.

In step S11, one website is randomly or manually selected from the crawled websites, and the selected website is placed into a website queue to be crawled. Optionally, multiple websites can be also randomly or manually selected from the crawled websites, and then the selected websites are placed into a website queue to be crawled at the same time and are arranged in order.

In step S12, according to the order of the website queue to be crawled, one website is taken out and then the homepage, the secondary page, and the tertiary page of this website are crawled.

In step S13, all the links included in all the pages of the crawled website are extracted, and the websites not been crawled are placed to the website queue to be crawled.

In step S14, it is determined whether the number of the crawled websites reaches a preset value or the website queue to be crawled is empty. If the number of the crawled websites does not reach the preset value or the website queue to be crawled is not empty, the processing returns to the step S12. If the number of the crawled websites reaches the preset value or the website queue to be crawled is empty, the processing goes to the step S2.

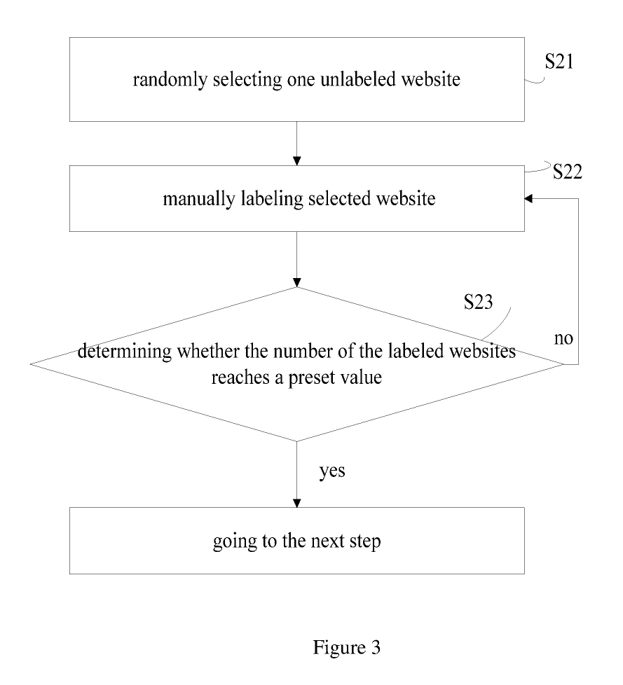

As shown in FIG. 3, in this embodiment, FIG. 3 is a flow chart for website labeling of FIG. 1, in which the step S2 for website labeling specially comprises following steps.

In step S21, one labeled website is randomly selected from all the websites have not been crawled.

In step S22, the selected website is opened and manually labeled.

In step S23, it is determined that whether the number of the labeled website reaches a preset value, if yes, the processing returns to the step 21, or else the processing goes to the step S3.

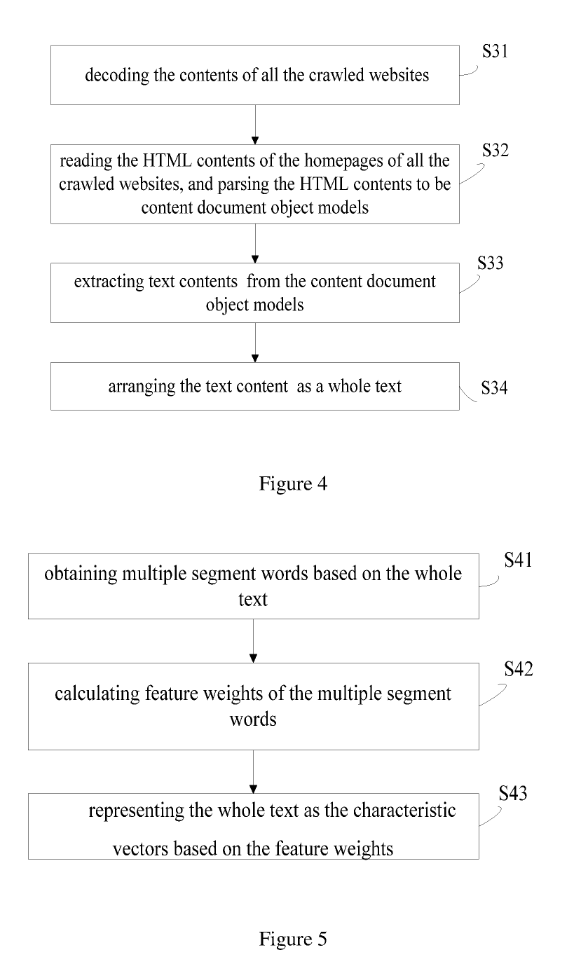

As shown in FIG. 4, in this embodiment, FIG. 4 is a flow chart for website information extracting of FIG. 1, in which the step S3 for website information extracting specially comprises following steps.

In step S31, the character encoding formats of all the crawled web sites are detected, and the contents of all the crawled websites are decoded.

In step S32, the HTML contents in the homepages of all the crawled websites are read, and then parsed into content document object models.

In step S33, text contents of the titles, key words of metadata and text contents of the description are extracted from the content document object models.

In step S34, the text contents of the titles, the key words of metadata and the text contents of the description are arranged in interval spaces in a whole text.

For example, different labels are used for separating and labeling each word mould in the HTML contents on the homepage of www.machine.com. For example, the contents of the website title are: <title> Shanghai Machinery Company </title>. The text contents between label <title> and label </title> will be automatically identify by the program, thus the following words “Shanghai Machinery Company” are extracted, and the metadata are extracted which comprise the description of “Shanghai famous machinery company, Shanghai machinery company homepage” and the key words of “Machinery Shanghai”. At last, they are connected by the space to get such a text “Shanghai Machinery Company Shanghai famous machinery company, Shanghai machinery company homepage Machinery Shanghai”.

As shown in FIG. 5, in this embodiment, FIG. 5 is a flow chart for website processing of FIG. 1, in which the step S4 for website processing specially comprises following steps.

In step S41, multiple segment words are obtained according to the whole text, then a word analyzer is used to divide the whole text into single word items which are easy to be processed. Each word term is used as the smallest unit in the algorithm. Then according to the Chinese stop word list, the word items having no meaning to the text are removed from the word list.

For example, the whole text obtained in the step S3 is pre-processed to be such a text that “Shanghai Machinery Company Shanghai famous machinery company Shanghai machinery company homepage Machinery Shanghai”.

In step S42, feature weights of the multiple segment words are calculated.

In step S43, the whole text is represented as the characteristic vectors based on the feature weights.

In this embodiment, TFIDF (term frequency-inverse document frequency) values of the words are taken as the feature weights, however any other similar characteristic weight calculation methods can be applied to the present application without departing the protection scope of the present application. Wherein the TFIDF value can be calculated as follows:

TFIDF(w)=TF(w)*IDF(w).

Wherein the value of the TF(w) is occurrence times of w in the feature weights of all the crawled web sites,

$$IDF ( w ) = log ( \frac{total}{occur ( w )} ) .$$

Wherein total denotes the number of the feature weights of all the crawled websites, the value of occur(w) is the number of the feature weights of the crawled websites containing w.

For example, the word “machinery” appears 4 times in the text obtained in the step S3, so TF(w)=4, and it appears 8453 times in all of the 100 000 websites.

So IDF(w)=log(100000/8453)=2.4706, and the weight of the word “machinery” is TFIDF(machinery)=4*2.4706=9.8824.

Further, after calculating the feature weights of the multiple segment words, according to the feature weights the whole text can be represented as characteristic vectors in the form of (t1:w1, . . . , t1:w1, . . . , tn:wn). Wherein t1, . . . , ti, . . . , tn denote the segment words obtained from the whole text; n denotes the total number of the characteristic vectors in a sample. Wherein wi denotes the weight of ti calculated from the step S42, and i denote an integer from 1 to n. For example, after calculating the weight of each word according to the above steps, such a vector is obtained as (Shanghai: 1.2384, famous: 0.8763, machinery: 9.8824, company: 1.5783, homepage: 0.1657).

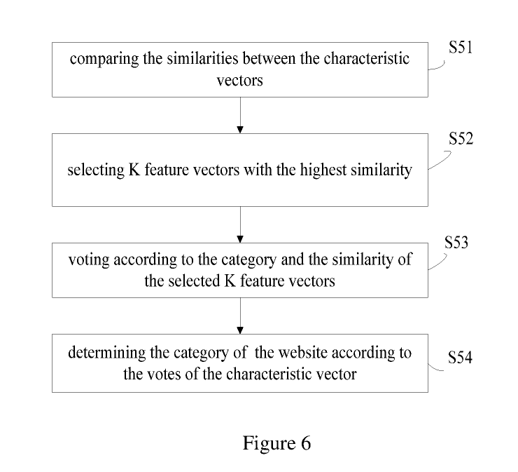

As shown in FIG. 6, in this embodiment, FIG. 6 is a flow chart for website classifying of FIG. 1, in which the step S5 for website classifying employs the K-NEAREST NEIGHBOR ALGORITHM and specially comprises following steps.

In step S51, the similarities between the characteristic vectors needed to be classified and the characteristic vectors of the manually classified and labeled websites are compared.

In step S52, K feature vectors with the highest similarity are selected.

In step S53, the selected K feature vectors are voted according to the category and the similarity thereof.

In step S54, the votes of the characteristic vectors with the same category are accumulated, and then the category with the highest votes is taken as the final category.

As the example, if K is 3, the three calculated website titles that are most similar with the “Shanghai Machinery Company” are “Guangdong Machinery Company”, “Changsha Machinery Company”, “Shanghai logistics company”, wherein the first two websites are manually labeled as machinery, and the third one is manually labeled as logistics. The final voting result is that the mechanical class has two votes, and the logistics class has one vote, so the final classification result is the mechanical class.

Finally, the category of the whole text extracting from the crawled websites is taken as the final category of the website classification.

For implementing the Chinese website classification method based on characteristic analysis of website homepage provided by the present application, the noise interference can be alleviated to the greatest extent by extracting only the titles and meta-information of the websites. By means of pre-processing and characteristic vector representation, the characteristics of the websites are accurately represented with the vectors, thus the accuracy of classification is increased. And since only titles and meta-information of the websites need to be processed, the quantity of data to be processed is small, and the processing speed is high.

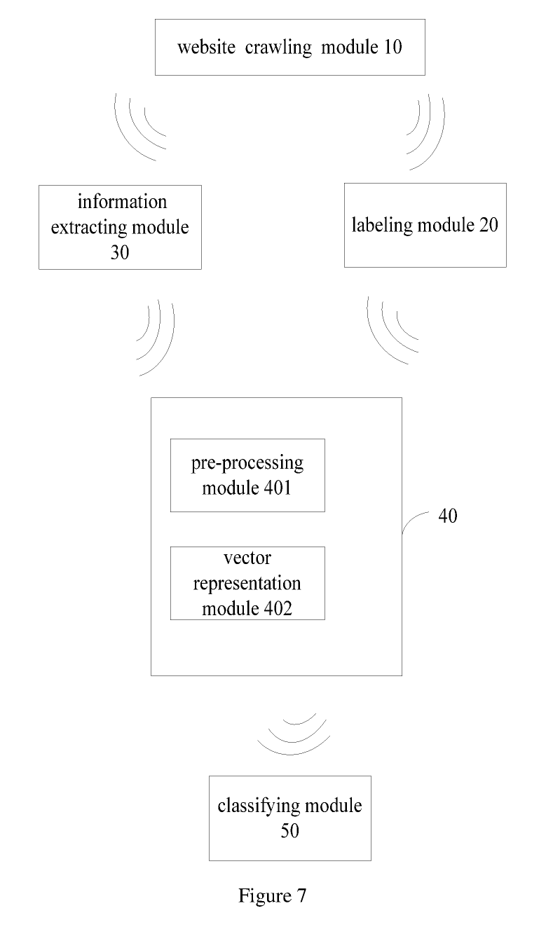

FIG. 7 is a block diagram of a Chinese website classification system based on characteristic analysis of website homepage, according to the present application. As shown in FIG. 7, it relates to a Chinese website classification system based on characteristic analysis of website homepage, which comprises a website crawling module (10) configured for crawling one to more websites and extracting contents of the websites, a labeling module (20) configured for manually labeling websites, an information extracting module (30) configured for parsing homepages of the websites and extracting titles and meta-information therein, a processing module (40) and a classifying module (50) configured for classifying the websites. The processing module (40) further comprises a pre-process module (401) and a vector representation module (402).

According to the web crawler technology, the website crawling module (10) employs the width optimization search method to find more web sites by starting from a few websites and based on the links between the websites. The pages of the websites are saved to the local server to crawl one to more websites and extract the contents of the crawled websites. The website crawling module (10) selects one or more websites and places the selected websites to a website queue to be crawled in order. Then the website crawling module (10) successively crawls the contents of the selected websites in order and extracts all of links of the crawled websites, and then places the websites not been crawled to the website queue to be crawled. After that, the website crawling module (10) determines whether the number of the crawled websites reaches a preset value or the website queue to be crawled is empty. If the number of the crawled websites does not reach the preset value or the website queue to be crawled is not empty, the website crawling module (10) extracts the website links and crawls the websites successively and repeatedly until the number of the crawled websites reaches the preset value or the website queue to be crawled is empty. If the number of the crawled websites reaches the preset value or the website queue to be crawled is empty, the website crawling module (10) stops crawling and sends the crawled websites to the labeling module (20) and the information extracting module (30).

The labeling module (20) randomly selects one unlabeled website after receiving the crawled websites from the website crawling module (10), and manually labels the selected websites. Then the labeling module (20) determines whether the number of the labeled website reaches a preset value, if yes, it randomly selects one unlabeled website and manually labels the selected website successively and repeatedly until the number of the labeled websites reaches the preset value; or else it stops labeling and sends website categories to the classifying module (50).

The information extracting module (30) detects character encoding formats of all the crawled websites, and decodes the contents of all the crawled websites after receiving the crawled websites from the website crawling module (10). Then the information extracting module (30) reads the HTML contents of the homepages of all the crawled websites, and parses the HTML contents to be content document object models. After that the information extracting module (30) extracts text contents of the titles, key words of metadata and text contents of the description from the content document object models, and arranges the text contents of the titles, the key words of metadata and the text contents of the description in interval spaces in a whole text, and then sends the whole text to the processing module (40).

The processing module (40) obtains multiple segment words based on the whole text after receiving the whole text, and calculates feature weights of the multiple segment words, and then represents the whole text as the characteristic vectors based on the feature weights. After that the processing module (40) sends the characteristic vector to the classifying module (50).

Wherein, the pre-processing module (401) can be configured for obtaining multiple segment words based on the whole text received from the information extracting module (30), calculating the feature weights of the multiple segment words. The pre-processing module (401) can be configured for taking TFIDF values of the segment words as the feature weights; and sending the feature weights to the vector representation module. Wherein the TFIDF value can be calculated as follows:

TFIDF(w)=TF(w)*IDF(w).

Wherein the value of the TF(w) is occurrence times of w in the feature weights of all the crawled web sites,

$$IDF ( w ) = log ( \frac{total}{occur ( w )} ) .$$

Wherein total denotes the number of the feature weights of all the crawled websites, the value of occur(w) is the number of the feature weights of the crawled web sites containing w.

The vector representation module represents the characteristic vectors received from the pre-processing module (401) as follows: (t1:w1, . . . , ti:wi, . . . , tn:wn), wherein t1, . . . , ti, . . . , tn denote the segment words obtained from the whole text; n denotes the total number of the characteristic vectors in a sample; wherein wi denotes the weight of ti calculated from the step S42, and i denotes an integer from 1 to n.

The classifying module (50) compares characteristic vectors needed to be classified with the characteristic vectors manually labeled to classify the crawled websites after receiving the website categories from the labeling module (20) and the characteristic vectors from the processing module (40).

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. A Chinese website classification method based on characteristic analysis of website homepage, comprising following steps:
step S1, crawling one to more websites and extracting contents of the websites;
step S2, selecting a pre-set quantity of crawled websites for manual classification and labeling the crawled websites;
step S3, parsing homepages of all crawled websites to extract titles and meta-information therein, wherein the meta-information comprises key words and description;
step S4, pre-processing the titles and the meta-information, calculating weights thereof, and representing the titles and the meta-information in forms of characteristic vectors according to the weights;
step S5, comparing all of the characteristic vectors with characteristic vectors of the manually classified and labeled websites to classify the websites.

2. The Chinese website classification method based on characteristic analysis of website homepage according to claim 1, wherein, the step S1 further comprises following steps:
step S11, selecting one website from the crawled websites and placing selected website into a website queue to be crawled in order;
step S12, successively crawling the contents of selected websites in order;
step S13, extracting all links of the crawled websites, and placing websites not been crawled to the website queue to be crawled;
step S14, determining whether the number of the crawled websites reaches a preset value or the website queue to be crawled is empty; if the number of the crawled websites does not reach the preset value or the website queue to be crawled is not empty, returning to step S12, if the number of the crawled websites reaches the preset value or the website queue to be crawled is empty, going to the step S2.

3. The Chinese website classification method based on characteristic analysis of website homepage according to claim 1, wherein, the step S2 further comprises following steps:
step S21, randomly selecting one unlabeled website;
step S22, manually labeling selected website;
step S23, determining whether the number of the labeled websites reaches a preset value; if not, returning to the step S21, or else, going to the step S3.

4. The Chinese website classification method based on characteristic analysis of website homepage according to claim 1, wherein, the step S3 further comprises following steps:
step S31, detecting character encoding formats of all the crawled websites, and decoding the contents of all the crawled websites;
step S32, reading HTML contents of the homepages of all the crawled websites, and parsing the HTML contents to be content document object models;
step S33, extracting text contents of the titles, key words of metadata and text contents of description from the content document object models;
step S34, arranging the text contents of the titles, the key words of metadata and the text contents of the description in interval spaces in a whole text.

5. The Chinese website classification method based on characteristic analysis of website homepage according to claim 4, wherein, the step S4 further comprises following steps:
step S41, obtaining multiple segment words based on the whole text;
step S42, calculating feature weights of the multiple segment words;
step S43, representing the whole text as the characteristic vectors based on the feature weights.

6. The Chinese website classification method based on characteristic analysis of website homepage according to claim 5, wherein, in the step S42 the feature weights are TFIDF values of the segment words, which can be calculated as follows:
TFIDF(w)=TF(w)*IDF(w)
Wherein, the value of the TF(w) is occurrence times of w in the feature weights of all the crawled web sites,
$$IDF ( w ) = log ( \frac{total}{occur ( w )} )$$
wherein total denotes the number of the feature weights of all the crawled websites, the value of occur(w) is the number of the feature weights of the crawled web sites containing w.

7. The Chinese website classification method based on characteristic analysis of website homepage according to claim 6, wherein the characteristic vector in the step S43 is (t1:w1, . . . , ti:wi, . . . , tn:wn), wherein t1, . . . , ti, . . . , tn denote the segment words obtained from the whole text; n denotes the total number of the characteristic vectors in a sample; wherein wi denotes the weight of ti calculated from the step S42, and i denotes an integer from 1 to n.

8. The Chinese website classification method based on characteristic analysis of website homepage according to claim 5, wherein, K-nearest neighbor algorithm is performed in the step S5.

9. A Chinese website classification system based on characteristic analysis of website homepage, comprising a website crawling module (10) configured for crawling one to more websites and extracting contents of the websites, a labeling module (20) configured for manually labeling websites, an information extracting module (30) configured for parsing homepages of the websites and extracting titles and meta-information therein, a processing module (40) and a classifying module (50) configured for classifying the websites, wherein;
the website crawling module (10) is configured for crawling one to more websites, extracting the contents of the websites and sending the contents of the websites to the labeling module (20) and the information extracting module (30);
the labeling module (20) is configured for selecting a pre-set quantity of the crawled websites for manual classification and labeling the websites;
the information extracting module (30) is configured for parsing homepages of all crawled websites to extract titles and meta-information therein and sending the titles and the meta-information to the processing module (40); the meta-information comprises key words and description;
the processing module (40) is configured for pre-processing the titles and the meta-information, calculating weights thereof, representing the titles and the meta-information in forms of characteristic vectors to the weight, and sending the characteristic vectors to the classifying module (50);
the classifying module (50) is configured for comparing all of characteristic vectors with the characteristic vector of the manually classified and labeled website to classify the website.

10. The Chinese website classification system based on characteristic analysis of website homepage according to claim 9, wherein, the website crawling module (10) is configured for selecting one or more websites and placing selected websites into a website queue to be crawled in order; successively crawling the contents of selected websites in order; extracting all of links of crawled websites, and placing the websites not been crawled to the website queue to be crawled; determining whether the number of the crawled websites reaches a preset value or the website queue to be crawled is empty, if the number of the crawled web sites does not reach the preset value or the website queue to be crawled is not empty, extracting the web site links and crawling the web sites successively and repeatedly until the number of the crawled websites reaches the preset value or the website queue to be crawled is empty; if the number of the crawled websites reaches the preset value or the website queue to be crawled is empty, stopping crawling, wherein the website crawling module (10) is configured for sending the crawled websites to the labeling module (20) and the information extracting module (30);
the labeling module (20) is configured for randomly selecting one unlabeled website after receiving the crawled websites from the website crawling module; manually labeling selected websites; and determining whether the number of the labeled website reaches a preset value, if yes, randomly selecting one unlabeled website and manually labeling the selected website successively and repeatedly until the number of the labeled websites reaches the preset value; or else, stopping labeling, wherein the labeling module (20) is further configured for sending website categories to the classifying module (50);
the information extracting module (30) is configured for detecting character encoding formats of all the crawled websites, and decoding the contents of all the crawled websites after receiving the crawled websites from the website crawling module (10); then reading the HTML contents of the homepages of all the crawled websites, and parsing the HTML contents to be content document object models; then extracting text contents of the titles, key words of metadata and text contents of the description from content document object models; arranging the text contents of the titles, the key words of metadata and the text contents of the description in interval spaces in a whole text, and finally sending the whole text to the processing module (40);
the processing module (40) is configured for obtaining multiple segment words based on the whole text after receiving the whole text; calculating feature weights of the multiple segment words; representing the whole text as the characteristic vectors based on the feature weights; sending the characteristic vectors to the classifying module (501);
wherein, the pre-processing module (401) is configured for obtaining multiple segment words based on the whole text received from the information extracting module (30); calculating feature weights of the multiple segment words; the pre-processing module (401) is configured for taking TFIDF values of the segment words as the feature weights; and sending the feature weights to the vector representation module (402), wherein the TFIDF value can be calculated as follows:
TFIDF(w)=TF(w)*IDF(w);
wherein the value of the TF(w) is occurrence times of w in the feature weights of all the crawled web sites,
$$IDF ( w ) = log ( \frac{total}{occur ( w )} ) ;$$
wherein total denotes the number of the feature weights of all the crawled websites, the value of occur(w) is the number of the feature weights of the crawled web sites containing w;
wherein the vector representation module (402) is configured for representing the characteristic vectors received from the pre-processing module (401) as follows: (t1:w1, . . . , ti:wi, . . . , tn:wn), wherein t1, . . . , ti, . . . , tn denote the segment words obtained from the whole text; n denotes the total number of the characteristic vectors in a sample; wherein wi denotes the weight of ti calculated from the step S42, and i denotes an integer from 1 to n;
the classifying module (50) is configured for comparing characteristic vectors needed to be classified with the characteristic vectors manually labeled to classify the crawled websites after receiving the website categories from the labeling module (20) and the characteristic vectors from the processing module (40).
